(19) United States
(12) Patent Application Publication
(10) Pub. No.: US 2019/0349686 A1
(43) Pub. Date: Nov. 14, 2019

(54) ULTRATHIN ASSEMBLED SPEAKER CONE

(71) Applicant: Hung-Wen Yu, Keelung City 206 (TW)

(72) Inventor: Hung-Wen Yu, Keelung City 206 (TW)

(21) Appl. No.: 15/973,533

(22) Filed: May 8, 2018

(51) Int. Cl. H04R 7/12; G10K 13/00; H04R 31/00

(52) U.S. Cl. CPC H04R 7/127; H04R 31/003; G10K 13/00

(57) ABSTRACT

An ultrathin assembled speaker cone includes a support frame and a vibrating diaphragm. The support frame has a first support portion, a second support portion, and a connecting portion connected between the first support portion and the second support portion. Through the vibrating diaphragm, the problem that the conventional speaker cone is not sufficiently lightweight is effectively solved, and the material of the vibrating diaphragm may have more diverse options.

### BACKGROUND OF THE INVENTION

### 1. Field of the Invention

The present invention relates to a speaker cone, and more particularly to an ultrathin assembled speaker cone.

### 2. Description of the Prior Art

In audio products, a loudspeaker has a function of converting the current signal output from the amplifier into a sound, which has a decisive influence on the overall sound output quality. The main principle of the loudspeaker is to combine a magnetic circuit device with a sound source, which generates a magnetic field change, and then drives the voice coil, the damper and the speaker cone of the loudspeaker to generate sound. The speaker cone functions as the main sounding component for the speaker. The speaker cone plays an important role in the speaker, which will influence the sound quality of the speaker. According to different materials, the speaker cone may be a full-paper speaker cone, composite speaker cone, Mylar speaker cone and so on. The speaker cone has three inherent characteristics: (1) lighter weight; (2) higher elasticity coefficient; (3) appropriate mechanical loss. Different materials of speaker cones have different characteristics.

For example, Chinese Patent No. CN100384301C discloses a speaker diaphragm, a dynamic speaker, and a process for manufacturing a speaker cone. However, this type of speaker cone has a one-piece structure. In order to ensure that the vibrating diaphragm has rigidity that can generate sound, a certain thickness is required. The material may not be too soft, resulting in that the weight of the speaker cone can't be reduced. It cannot be truly lightweight and its structure is still greatly limited.

### SUMMARY OF THE INVENTION

In view of the shortcomings of the prior art, the primary object of the present invention is to provide an ultrathin assembled speaker cone. Through a support frame and a vibrating diaphragm, the problem that the conventional speaker cone is not sufficiently lightweight is effectively solved, and the material of the vibrating diaphragm may have more diverse options.

In order to achieve the aforesaid object, the ultrathin assembled speaker cone of the present invention comprises a support frame and a vibrating diaphragm that are separately provided. The support frame has a first support portion, a second support portion, and a connecting portion connected between the first support portion and the second support portion. A space is defined between the first support portion and the second support portion. The first support portion has a diameter greater than that of the second support portion. The connecting portion divides the space between the first support portion and the second support portion into a plurality of hollow cavities. At least upper and lower ends of the vibrating diaphragm are fixed to the first support portion and the second support portion, respectively.

Compared with the prior art, the present invention has obvious advantages and beneficial effects. Specifically, from the above technical solutions, it can be known that the conventional integrated speaker cone is divided into two parts, a support frame and a vibrating diaphragm. Wherein, the support frame is mainly used to provide rigidity, so that the speaker cone is able to generate vibration and sound. After the vibrating diaphragm is supported on the support frame, it can be made thinner and lighter. The material selection can be more diversified to meet various high and low pitch requirements. Therefore, the problem that the speaker cone is not thin enough is solved, and the flexibility of the speaker cone is improved.

### BRIEF DESCRIPTION OF THE DRAWINGS

FIG. 1 is an exploded view according to a first embodiment of the present invention;

FIG. 2 is another exploded view according to the first embodiment of the present invention;

FIG. 3 is a front view of the support frame according to the first embodiment of the present invention;

FIG. 4 is a sectional view of the support frame and the vibrating diaphragm according to the first embodiment of the present invention;

FIG. 5 is an exploded view according to a second embodiment of the present invention;

FIG. 6 is another exploded view according to the second embodiment of the present invention;

FIG. 7 is a front view of the support frame according to the second embodiment of the present invention;

FIG. 8 is an exploded view according to a third embodiment of the present invention;

FIG. 9 is another exploded view according to the third embodiment of the present invention;

FIG. 10 is a front view of the support frame according to the third embodiment of the present invention;

FIG. 11 is an exploded view according to a fourth embodiment of the present invention;

FIG. 12 is another exploded view according to the fourth embodiment of the present invention;

FIG. 13 is a schematic diagram of a first manufacturing process of the present invention; and

FIG. 14 is a schematic diagram of a second manufacturing process of the present invention.

### DETAILED DESCRIPTION OF THE PREFERRED EMBODIMENTS

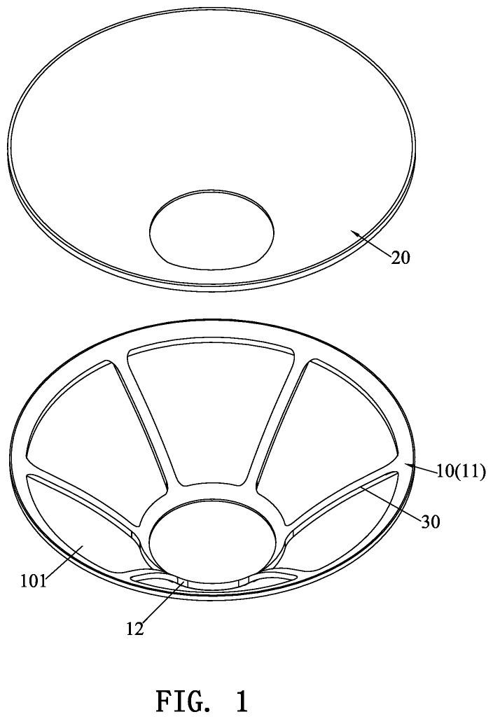

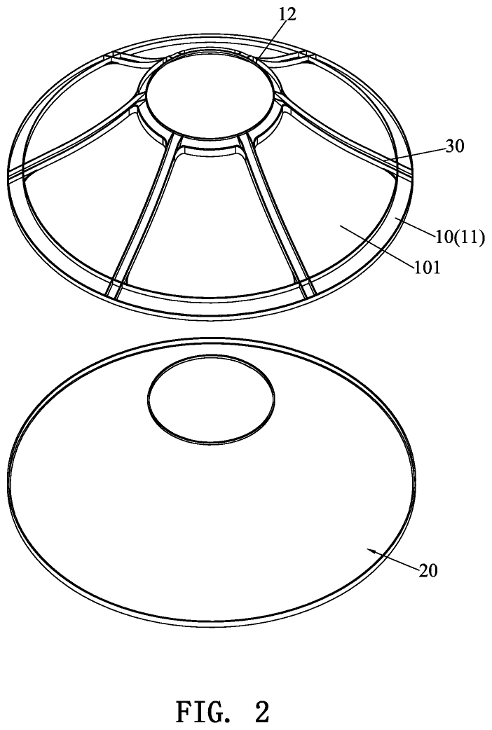

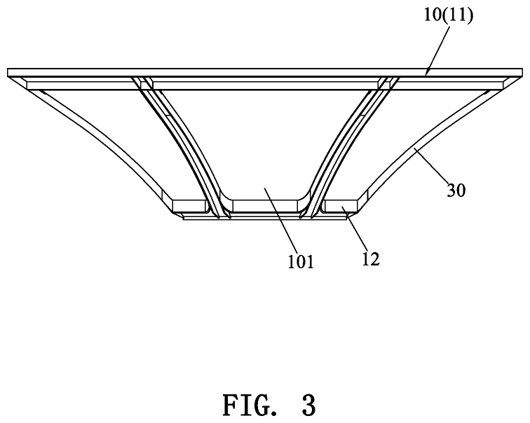

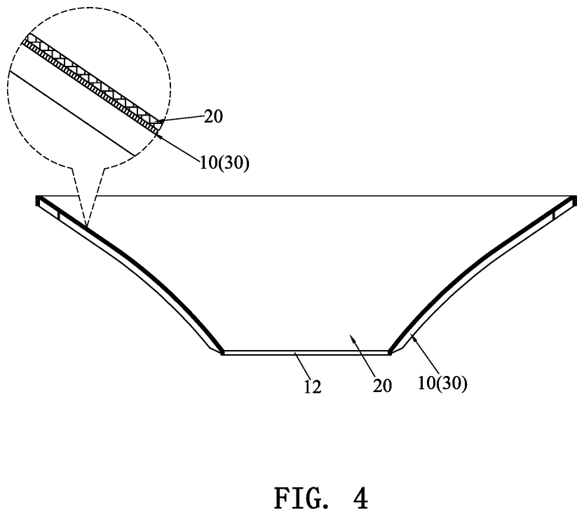

FIGS. 1-4 show a specific structure of a first embodiment of the present invention, comprising a support frame 10 and a vibrating diaphragm 20 that are separately provided.

The support frame 10 has a first support portion 11, a second support portion 12, a connecting portion connected between the first support portion 11 and the second support portion 12. A space is defined between the first support portion 11 and the second support portion 12. The diameter of the first support portion 11 is greater than the diameter of the second support portion 12. The connecting portion divides the space between the first support portion 11 and the second support portion 12 into a plurality of hollow cavities 101. For example, the connecting portion includes six spaced connecting portions arranged between the first support portion 11 and the second support portion 12. The connecting portions are arranged only in the necessary positions, and other positions are hollow to effectively reduce the weight of the support frame 10. Of course, in the actual production, the number of connecting portions may be adjusted according to the size of the speaker cone, and is not limited to this embodiment.

In this embodiment, the connecting portion is a first connecting rib 30. The first connecting rib 30, the first support portion 11 and the second support portion 12 are of an integral structure. Wherein, the first support portion 11 and the second support portion 12 are each in a circular shape. The first support portion 11, the second support portion 12, and the connecting portion of the support frame 10 are all made of a plastic material, and may be formed by injection molding. The production is simple and convenient. Of course, the support frame 10 may be made other materials, such as wood or metal materials. The first connecting rib 30 is inwardly curved. The vibrating diaphragm 20 is adhered to the inner surfaces of the first support portion 11 and the second support portion 12 and the first connecting rib 30 so that the vibrating diaphragm 20 is fully affixed.

The vibrating diaphragm 20 may be made of any material, such as carbon fiber, glass fiber, full paper, Mylar, cowhide, bulletproof fiber, composite material, leather, and the like. The vibrating diaphragm 20 provided in this way can effectively solve the problem that the conventional speaker cone is not thin enough. The vibrating diaphragm 20 can use any material as a thin diaphragm, thereby improving the flexibility of selecting the material of the vibrating diaphragm. In addition, the vibrating diaphragm 20 can be attached to different materials of the support frame 10, thereby improving the flexibility of use of the vibrating diaphragm 20.

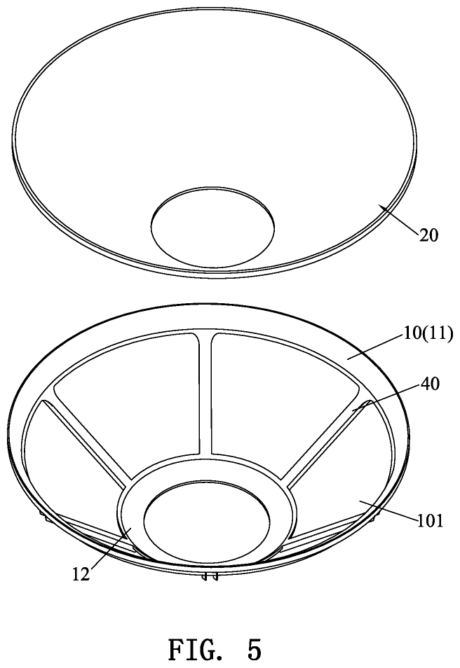

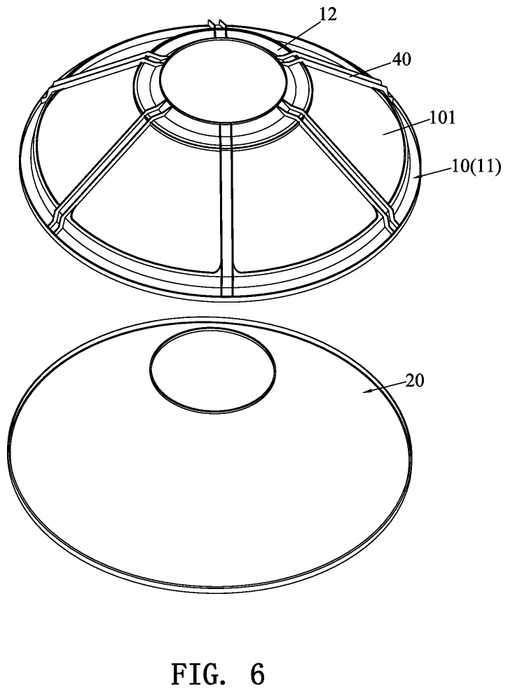

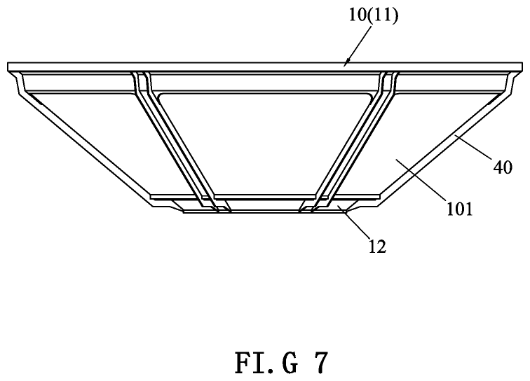

FIGS. 5 to 7 show the specific structure of a second embodiment of the present invention. The second embodiment is substantially similar to the first embodiment with the exceptions described hereinafter. The connecting portion is a second connecting rib 40. The second connecting rib 40, the first support portion 11 and the second support portion 12 are of an integral structure. The second connecting rib 40 is straightly disposed. When the vibrating diaphragm 20 is affixed, only upper and lower ends of the vibrating diaphragm 20 are attached to the first support portion and the second support portion with glue. The other portion of the vibrating diaphragm 20 is suspended and is not in contact with the second connecting rib so that the vibrating diaphragm 20 is partially affixed.

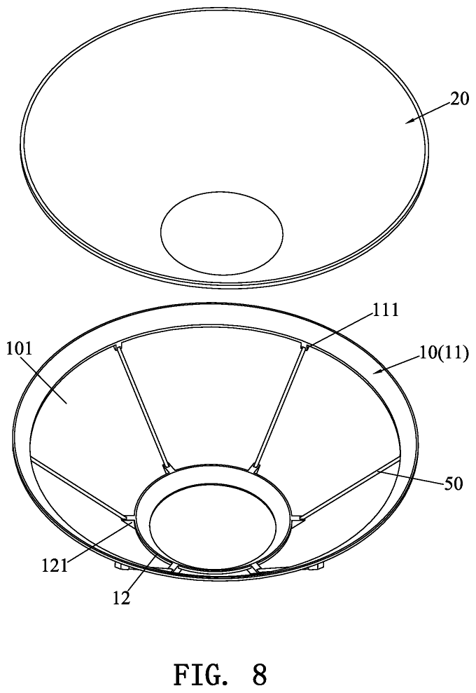

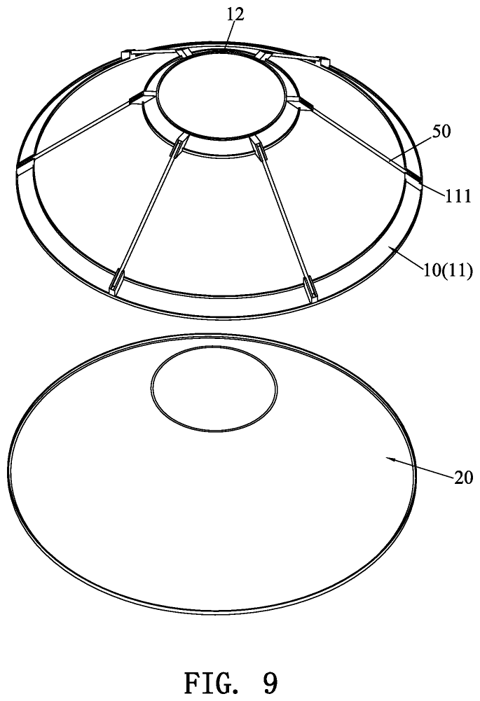

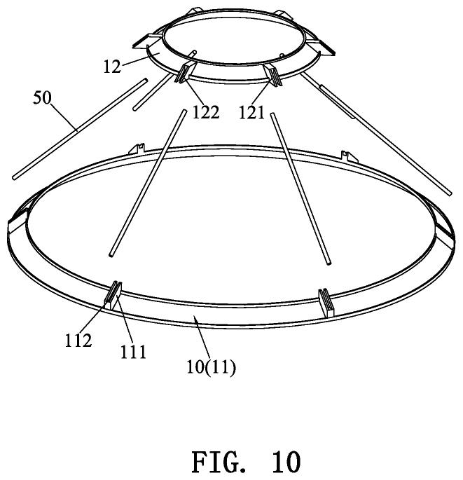

FIGS. 8 to 10 show the specific structure of a third embodiment of the present invention. The third embodiment is substantially similar to the first embodiment with the exceptions described hereinafter. The connecting portion is a connecting rod 50. The connecting rod 50 is an integral elongated rod. Specifically, the first support portion 11 is provided with a plurality of first positioning portions 111 on the outer surface thereof. The second support portion 12 is provided with a plurality of second positioning portions 121 on the outer surface thereof. The first positioning portions 111 correspond to the second positioning portions 121, respectively. Two ends of the connecting rod 50 are fixed to a corresponding one of the first positioning portions 111 and a corresponding one of the second positioning portions 121, respectively. The present embodiment adopts a detachable engaging way. The specific structure is as follows: the first positioning portions 111 each have a first groove 112, and the second positioning portions 121 each have a second groove 122. The two ends of the connecting rod 50 are inserted into the first groove 112 and the second groove 122 to be fixedly connected, respectively. The advantage of this structural design is that the first support portion 11 and the second support portion 12 are first formed separately, and then the connecting rod 50 can be cut for a desired length according to the specific size of the speaker, and then the connecting rod 50 is assembled and connected to the first support portion 11 and the second support portion 12 so that the size of the speaker cone can be adjusted.

In addition, the first support portion 11, the second support portion 12 and the connecting rod 50 are formed separately and then assembled together, and they may be made of different materials. For example, the first support portion 11 and the second support portion 12 are made of a plastic material, and the connecting portion is a solid silicone steel rod made of a metal material. Through the combination of different materials, the product meets the rigid demand and is thinner and lighter.

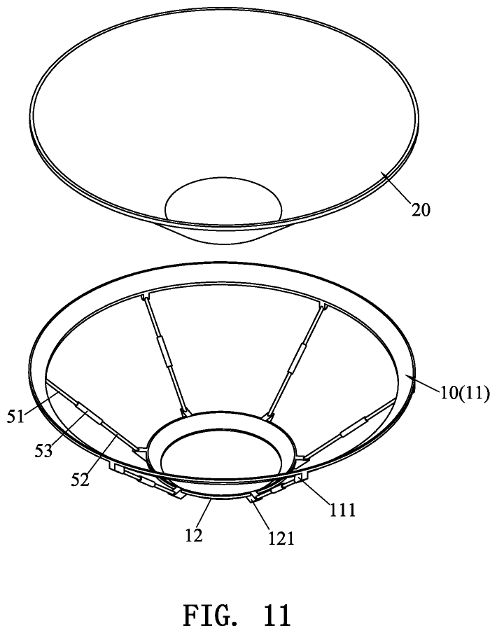

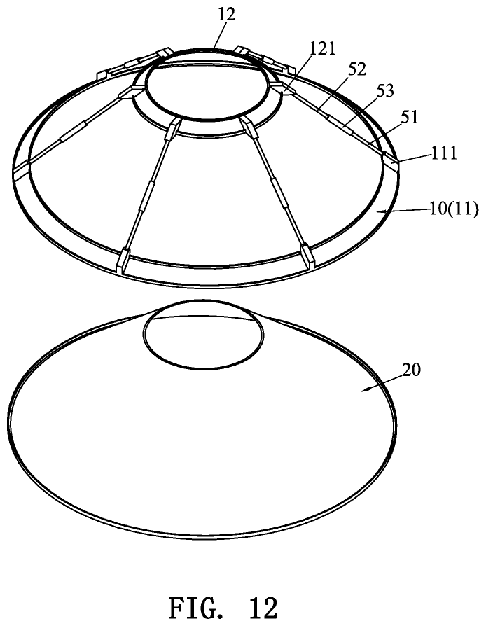

FIGS. 11 to 12 show the specific structure of a fourth embodiment of the present invention. The fourth embodiment is substantially similar to the third embodiment with the exceptions described hereinafter. The connecting rod 50 is an assembled connected rod. Specifically, the connecting rod 50 includes a first rod body 51, a second rod body 52, and a nut 53. The first rod body 51 has a right-handed screw thread. The second rod body 52 has a left-handed screw thread. The first rod body 51 and the second rod body 52 are screwedly connected to two ends of the nut 53, respectively. In this way, the length of the connecting rod can be adjusted freely, and the adjustment is achieved by the screw threads of the first rod body 51, the second rod body 52 and the nut 53.

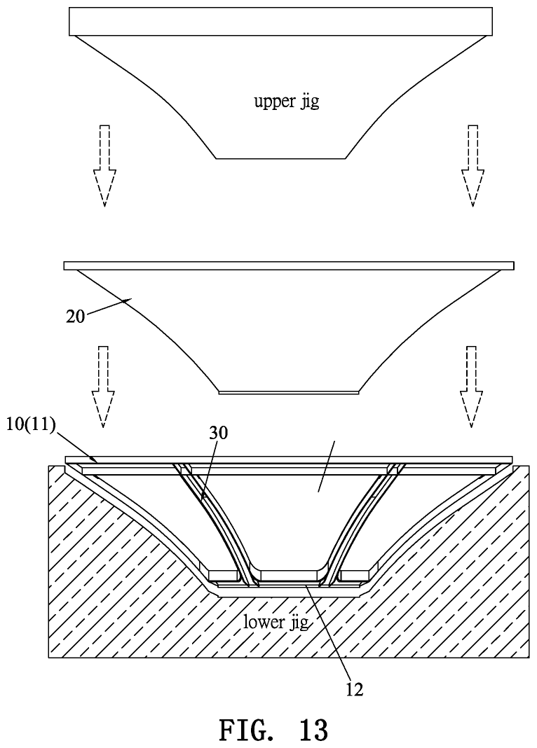

Specifically, referring to FIG. 13, a first manufacturing process is applicable to the first embodiment. The first manufacturing process is performed through upper and lower jigs by hydraulic pressure. The upper jig has a convex portion for placing the vibrating diaphragm 20. The lower jig has a cavity for placing the support frame 10. The vibrating diaphragm 20 is attached to the support frame 10 by hydraulic pressure. Firstly, the support frame 10 is placed in the lower jig, and the support frame 10 is limited and fixed by the upper end portion and the bottom portion of the cavity of the lower jig; thereafter, the vibrating diaphragm 20 is placed in the convex portion of the upper jig, and the glue is evenly applied on the support frame 10; finally, the upper jig is pressed down toward the lower jig by a hydraulic press, so that the vibrating diaphragm 20 is attached to the support frame 10.

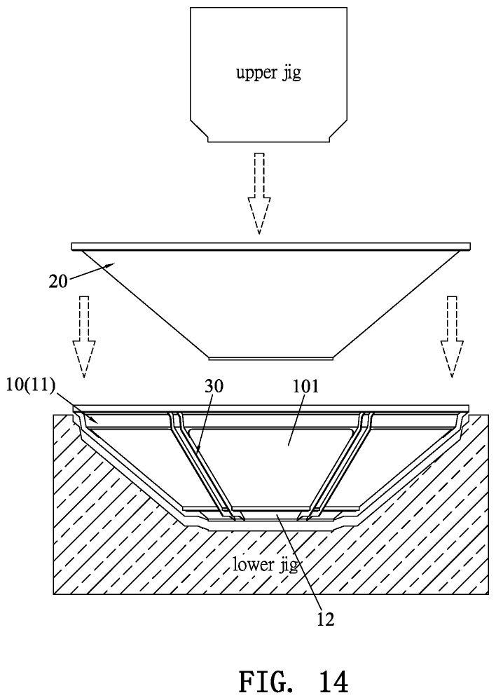

Referring to FIG. 14, a second manufacturing process is substantially similar to the first manufacturing process, except that the upper jig is smaller in size. The second manufacturing process is applicable to the second, third and fourth embodiments. In the second manufacturing process, the bottom of the vibrating diaphragm 20 is placed on the bottom of the upper jig, and the support frame 10 is placed in the same way as the first manufacturing process; thereafter, the glue is evenly applied to the first support portion 11 and the second support portion 12 of the support frame 10. Finally, the upper jig is pressed down by a hydraulic press. In the pressing down process, the upper end of the vibrating diaphragm 20 is attached to the first support portion 11. The vibrating diaphragm 20 is stretched downward by the upper jig 20 so that the lower end of the vibrating diaphragm 20 is completely attached to the second support portion 12. The speaker cone produced by the hydraulic process may be made of any material, such as aluminum, cloth, paper, metal, plastic, and the like.

Of course, if the vibrating diaphragm 20 is made of a plastic material, it can be fixed on the support frame 10 by a blister process. When a blister technique is used, it is not necessary to use an upper jig, and only the lower jig is replaced with a jig having an air suction hole at the bottom thereof. In the production, the fixing manner of the support frame 10 is basically the same as the first manufacturing process and the second manufacturing process; after that, the vibrating diaphragm 20 is placed on the support frame 10, and the vibrating diaphragm 20 is softened by heating. Finally, the vibrating diaphragm 20 is adsorbed, deformed, and adhered to the support frame 10 by a blister machine.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An ultrathin assembled speaker cone, comprising a support frame and a vibrating diaphragm, the support frame having a first support portion, a second support portion and a connecting portion connected between the first support portion and the second support portion, a space being defined between the first support portion and the second support portion, the first support portion having a diameter greater than that of the second support portion, the connecting portion dividing the space between the first support portion and the second support portion into a plurality of hollow cavities; at least upper and lower ends of the vibrating diaphragm being fixed to the first support portion and the second support portion, respectively.

2. The ultrathin assembled speaker cone as claimed in claim 1, wherein the connecting portion is a first connecting rib, the first connecting rib, the first support portion and the second support portion are of an integral structure, the first connecting rib is inwardly curved; the vibrating diaphragm is adhered to inner surfaces of the first support portion and the second support portion and the first connecting rib.

3. The ultrathin assembled speaker cone as claimed in claim 1, wherein the connecting portion is a second connecting rib, the second connecting rib, the first support portion and the second support portion are of an integral structure, the second connecting rib is straightly disposed, and the vibrating diaphragm is adhered to the first support portion and the second support portion.

4. The ultrathin assembled speaker cone as claimed in claim 1, wherein the connecting portion is a connecting rod, the first support portion is provided with a plurality of first positioning portions on an outer surface thereof, the second support portion is provided with a plurality of second positioning portions on an outer surface thereof, the first positioning portions correspond to the second positioning portions respectively; two ends of the connecting rod are fixed to a corresponding one of the first positioning portions and a corresponding one of the second positioning portions, respectively.

5. The ultrathin assembled speaker cone as claimed in claim 4, wherein the first positioning portions each have a first groove, the second positioning portions each have a second groove, the two ends of the connecting rod are inserted into the first groove and the second groove to be fixedly connected, respectively.

6. The ultrathin assembled speaker cone as claimed in claim 4, wherein the connecting rod is an integral elongated rod.

7. The ultrathin assembled speaker cone as claimed in claim 4, wherein the connecting rod is an assembled connected rod.

8. The ultrathin assembled speaker cone as claimed in claim 7, wherein the connecting rod includes a first rod body, a second rod body and a nut, the first rod body has a right-handed screw thread thereon, the second rod body has a left-handed screw thread thereon; the first rod body and the second rod body are screwedly connected to two ends of the nut, respectively.
